(19) United States
(12) Patent Application Publication
(10) Pub. No.: US 2012/0234457 A1
(43) Pub. Date: Sep. 20, 2012

(54) METHOD FOR UPGRADING THE PERFORMANCE OF AN ELECTRONIC DEVICE

(76) Inventor: David J. SCHULTE, Harbor Springs, MI (US)

(21) Appl. No.: 13/421,558

(22) Filed: Mar. 15, 2012

Related U.S. Application Data
(60) Provisional application No. 61/452,993, filed on Mar. 15, 2011.

(51) Int. Cl. B32B 37/12; B32B 41/00

(52) U.S. Cl. 156/64; 156/60; 156/185

(57) ABSTRACT

There is disclosed a method of upgrading the performance of an electronic device comprising: (a) providing the electronic device having at least one electrical component; (b) providing a ferrite plate having a bottom side and an adhesive disposed on the bottom side; and (c) adhering the ferrite plate atop the electrical component using the adhesive on the bottom side of the ferrite plate.

### CROSS REFERENCE TO RELATED APPLICATION

This application claims the benefit of U.S. Provisional Application 61/452,993, which was filed on Mar. 15, 2011, the disclosure of which is hereby incorporated by reference.

### BACKGROUND OF THE INVENTION

1. Field of the Invention

The present invention pertains to a method for upgrading the performance of an electronic device. More particularly, the present invention pertains to a method for upgrading the performance of an electronic device by shielding electrical components in the electronic device from electromagnetic interference.

2. Description of the Prior Art

Electromagnetic interference (EMI), also called radio frequency interference (RFI) when in high or radio frequencies, is disturbance that affects an electrical circuit or components due to either electromagnetic induction or electromagnetic radiation emitted from an external source. The disturbance may interrupt, obstruct, or otherwise degrade or limit the effective performance of the circuit or component. These effects can range from a simple degradation of signal to a total loss of signal. The EMI/RFI source may be any object, either artificial or natural, which carries rapidly changing electrical currents, such as an electrical circuit.

Due to concerns over EMI, the Federal Communications Commission (FCC) has been given the authority to regulate the susceptibility of consumer electronic equipment sold in the country. The FCC has developed standards for EMI immunity for consumer electronics products.

In addition, today's electronic devices, particularly the high-end audio and video components, are susceptible to EMI/RFI-caused degradation of performance. The high-end performance standards are so high today that EMI and RFI produce a noticeable degradation in performance. In addition, the widespread use of modern electronics like computers, televisions, and cellular telephones create EMI and RFI which constantly bombard electronic devices. Even more so, the electronic devices themselves have various electrical components which can produce EMI or RFI which affect other electrical components within the same electronic device.

It is well-known that ferritic materials (i.e., materials containing ferrous oxide) are effective at shielding electromagnetic interference (EMI) as well as radio frequency interference (RFI). Electromagnetic shielding is the process of reducing the electromagnetic field in a space by blocking the field with barriers made of conductive or magnetic materials. Shielding is typically applied to enclosures to isolate the electronic devices from the environment.

As understood by those having ordinary skill in the art, the basic composition of ferritic materials is a combination of ferrous oxide and one or more other powdered metal, which is often manganese, zinc, cobalt, or nickel. The powder is pressed and then sintered into a crystalline ceramic pipe kiln firing at about 2000° F. for prescribed durations. These materials are available in a wide variety of shapes and sizes.

In addition, a wide variety of mixtures and performance levels are possible, and each discrete ferrite formulation has an individual combination of electrical, magnetic, and mechanical characteristics. The most common expression of a ferrite's performance capabilities is in terms of its permeability, which is a property that determines the ratio of the magnitude of magnetic induction to the magnetizing force.

Ferritic materials are desirable for shielding EMI and RFI because they function by adding greater resistive impedance at high frequencies that are beyond the ferrites' inherent ferromagnetic resonant frequencies. The ferromagnetic resonant frequency is that frequency where a decrease in initial permeability and a rapid increase in high-frequency losses become quite evident. It is this greater resistive impedance which allows this basically passive, apparently simple material to suppress multiple signals in a variety of application situations.

The most important advantage of ferrite is its high resistivity. Ferrite has a concentrated, homogenous magnetic structure with high permeability that is consistently stable over time and through wide temperature ranges and has no high eddy current losses.

As disclosed in U.S. Pat. No. 5,621,611 to Kizuya et al., ferrite shielding is also typically used on electrical cables to insulate the wires from the environment. Shielding used on cables often comprises a cylindrical or toroidal core that is placed around the cable to form a 360° enclosure.

Shielding can reduce the coupling of radio waves, electromagnetic fields, and electrostatic fields. As known in the art, Faraday cages are conductive enclosures used to block the electrostatic fields. The amount of reduction depends upon the material used, the thickness of the material, the size of the shielded object, the frequencies of the shielded signals, and the size, shape, and orientation of any apertures in the shield to an incident electromagnetic field. As understood by those having ordinary skill in the art, any holes in the shield must be significantly smaller than the wavelength of the radiation that is being blocked, or the enclosure will not effectively approximate an unbroken conducting surface.

As disclosed in U.S. Pat. No. 4,474,676 to Ishino et al., another known method for shielding electronic goods is to coat the inside surface of the device's enclosure (e.g., a computer housing) with a ferromagnetic amorphous alloy to block any EMI or RFI from entering from the outer environment. However, EMI/RFI from one electrical component can affect another electrical component within the same electronic device.

Therefore, there remains a need to shield specific electrical components which are prone to transmit or receive EMI or RFI. Manufacturers of electronic devices are not inclined to shield the electrical components within the device because doing so would drive up cost, and the manufacturers presumably feel that the products' performance are adequate since consumers are purchasing the products to begin with. Nonetheless, discerning consumers in the high-end market are still looking to upgrade the performance of their electronic devices. Thus, there remains a need for upgrading the performance of the electronic device by shielding specific electrical components.

The present invention, as is detailed hereinbelow, seeks to fill this need by providing a method for upgrading the performance of an electronic device by shielding electrical components in the electronic device from electromagnetic interference.

### SUMMARY OF THE INVENTION

The present invention provides a method of upgrading the performance of an electronic device comprising: (a) providing the electronic device having at least one electrical component; (b) providing a ferrite plate having a bottom side and an adhesive disposed on the bottom side; and (c) adhering the ferrite plate atop the electrical component using the adhesive on the bottom side of the ferrite plate.

In another embodiment, there is provided a method of upgrading the performance of an electronic device comprising: (a) providing the electronic device having a plurality of electrical components; (b) identifying, out of the plurality of electrical components, at least one sensitive electrical component that either transmits or receives electromagnetic interference during operation of the electronic device; (c) providing at least one ferrite plate, each ferrite plate having a bottom side and an adhesive disposed on the bottom side; and (d) adhering a respective one of the ferrite plates atop each sensitive electrical component, thereby shielding each sensitive electrical component from either transmitting or receiving electromagnetic interference.

In yet another embodiment, there is provided a method of shielding a wire from electromagnetic interference comprising: (a) providing an electronic device including a wire which transmits electrical current during use of the electronic device; (b) providing a flexible elongated tape having electromagnetic-shielding properties, the tape having an adhesive disposed on a bottom side of the tape; and (c) wrapping the tape helically around the wire to cover a continuous length of the wire with the tape, thereby shielding the wire from electromagnetic interference.

According to the embodiments above, the electronic device can be selected from the group consisting of: preamplifiers, power amplifiers, DVD players, DVD recorders, cd/sacd players, CD recorders, Blu-Ray Disc® players, Blu-Ray Disc® recorders, laserdisc players, VCR players/recorders, satellite receivers, satellite transmitters, cable TV receivers, cable TV transmitters, cellular telephones, cellular telephone receivers, cellular telephone transmitters, plasma monitors, LED monitors, LCD monitors, laser monitors, vacuum-tube monitors, televisions, video projectors, powerline conditioners, powerline protectors, battery backups, desktop computers, laptop computers, handheld computers, computing tablets, personal digital assistants, handheld video game consoles, video game consoles, handheld audio devices, active loudspeakers, surround-sound processors, video switchers, video routers, video amplifiers, cameras, HDMI® routers, HDMI® switchers, camcorders, microphone preamplifiers, phono preamplifiers, mixers, mastering equipment, music servers, music storage devices, movie storage devices, routers, home automation devices, stereo receivers, surround sound A/V receivers, digital-to-analog converters, analog-to-digital converters, transports, buffers, equalizers, post-processing devices, enhancers, scalers, and imaging devices.

In addition, the electrical component can be selected from the group consisting of: voltage regulators, diodes, rectifiers, digital chips, computer chips, memory chips, op-amps, transistors, resistors, VLSI chips, LSI chips, audio chips, video chips, circuit board traces, opto-couplers, relay housings, plugs, relays, flat-ribbon connectors, circuit board connectors, fuses, and flat-ribbon conductors.

Preferably, the ferrite plate includes at least one of the materials selected from the group consisting of: manganese, zinc, cobalt, and nickel. In addition, each ferrite plate is preferably about 0.5 mm to about 5.0 mm thick, depending upon the size of the component and the strength of the EMI/RFI. Preferably, the ferrite plate has a length and a width that are substantially the same as that of the electrical component upon which the ferrite plate is adhered. In addition, the adhesive is preferably a pressure-sensitive adhesive.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 is a perspective view of an embodiment of the present invention hereof;

FIG. 2 is a second perspective view of an embodiment of the present invention; and

FIG. 3 is a perspective of another embodiment of the present invention.

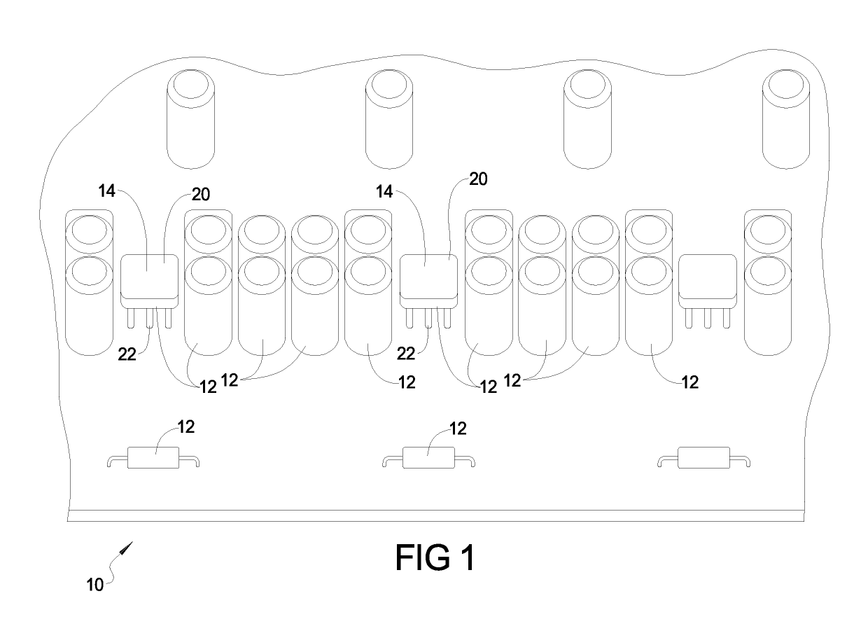

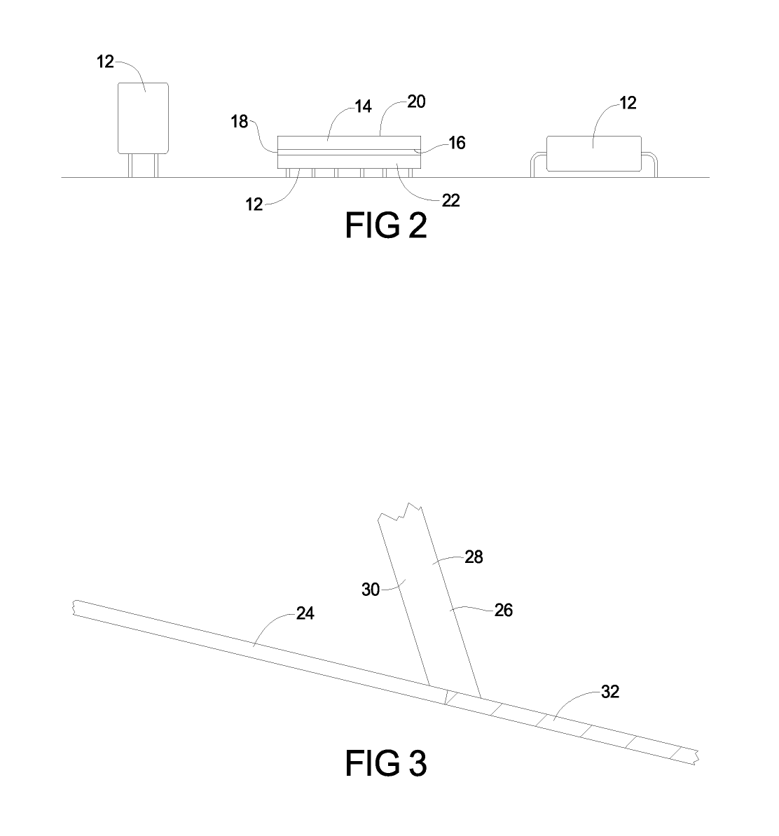

### DETAILED DESCRIPTION OF THE PREFERRED EMBODIMENT

At the onset, it is noted that the following method for upgrading the performance of an electronic device can be used on any suitable electronic device and any electrical component therein.

In accordance with the present invention, there is provided a method of upgrading the performance of an electronic device 10 comprising: (a) providing the electronic device 10 having at least one electrical component 12; (b) providing a ferrite plate 14 having a bottom side 16 and an adhesive 18 disposed on the bottom side 16; and (c) adhering the ferrite plate 14 atop the electrical component 12 using the adhesive 18 on the bottom side 16 of the ferrite plate 14.

The electronic device 10 can be any suitable device known to one having ordinary skill in the art. More particularly, the electronic device 10 can include, but is not limited to, preamplifiers, power amplifiers, DVD players, DVD recorders, cd/sacd players, CD recorders, Blu-Ray Disc® players, Blu-Ray Disc® recorders, laserdisc players, VCR players/recorders, satellite receivers, satellite transmitters, cable TV receivers, cable TV transmitters, cellular telephones, cellular telephone receivers, cellular telephone transmitters, plasma monitors, LED monitors, LCD monitors, laser monitors, vacuum-tube monitors, televisions, video projectors, powerline conditioners, powerline protectors, battery backups, desktop computers, laptop computers, handheld computers, computing tablets, personal digital assistants, handheld video game consoles, video game consoles, handheld audio devices, active loudspeakers, surround-sound processors, video switchers, video routers, video amplifiers, cameras, HDMI® routers, HDMI® switchers, camcorders, microphone preamplifiers, phono preamplifiers, mixers, mastering equipment, music servers, music storage devices, movie storage devices, routers, home automation devices, stereo receivers, surround sound A/V receivers, digital-to-analog converters, analog-to-digital converters, transports, buffers, equalizers, post-processing devices, enhancers, scalers, and imaging devices.

In addition, the electrical component 12 can be any suitable component or circuitry known to one having ordinary skill in the art. More particularly, the electrical component 12 can include, but is not limited to, voltage regulators, diodes, rectifiers, digital chips, computer chips, memory chips, op-amps, transistors, resistors, VLSI chips, LSI chips, audio chips, video chips, circuit board traces, printed circuit boards, opto-couplers, relay housings, plugs, relays, flat-ribbon connectors, circuit board connectors, fuses, and flat-ribbon conductors.

The ferrite plate 14 can be in the form of any suitable shape (e.g., curved, non-planar, etc.), but it is preferably flat and planar so that it is positionable flat atop the electrical component 12. The ferrite plate 14 can be square, rectangular, circular, oblong, or any other suitable shape. In use, the ferrite plate 14 has a length and width that can range from 2 mm to 50 mm, although dimensions outside that range are perfectly suitable if the particular application calls for it. Preferably, the ferrite plate 14 has an upper surface 20 and a lower surface (or bottom side 16) that are each substantially flat and planar. Preferably, the ferrite plate 14 has a length and a width that are substantially the same as that of the electrical component 12 upon which the ferrite plate 14 is adhered.

As understood by those having ordinary skill in the art, the ferrite plate 14 can comprise either soft or hard ferrite. It is understood that soft ferrite does not retain significant magnetization, whereas hard ferrite magnetization is considered permanent.

Ferrite has a cubic crystalline structure with the chemical formula MO·Fe₂O₃ where Fe₂O₃ is iron oxide and MO refers to a combination of two or more divalent metal (e.g., zinc, nickel, manganese, cobalt, and copper) oxides. The addition of such metal oxides in various amounts allows the creation of many different materials whose properties can be tailored for a variety of uses.

The thickness of the ferrite plate 14 is in the range of about 0.5 mm to about 5.0 mm thick. The preferred thickness will be application-specific and depends upon the size of the component and the strength of the EMI/RFI.

Although not necessary, the bottom side 16, or lower surface of the ferrite plate 14 can include the adhesive 18 to adhere the ferrite plate 14 to the electrical component 12. Any suitable adhesive can be used herewith, although the adhesive 18 is preferably pressure-sensitive and includes a peel-away liner so that the liner can be easily removed and the ferrite plate 14 can be easily adhered to the electrical component 12.

As stated above, the ferrite plate 14 is preferably positioned directly atop the electrical component 12. As the distance between the ferrite plate 14 and the electrical component 12 increases, the EMI/RFI shielding efficiency of the ferrite plate 14 decreases. Thus, it is desirable to place the ferrite plates 14 directly on the electrical components 12.

Not wishing to be bound to any particular theory, it is believed that the ferrite plate 14 resonates the EMI/RFI frequencies and converts these energies into heat, thereby dissipating the EMI/RFI rather than reflecting it back to other electrical components 12 like circuitry, connections, wiring, and so forth. The ferrite material also causes an electrical phenomenon called inductance which truncates the RF energies. As discussed above, the ferrite can be customized so that ferrite having particular shielding properties can be used to block specific ranges of EMI/RFI while allowing other frequencies to pass through.

To that effect, an additional step in the method claimed herein can optionally include properly assessing the frequency ranges that are to be shielded and use a suitable ferrite shield which blocks those frequency ranges.

Alternatively, the ferrite plate 14 can be replaced by a plate of similar geometry and dimensions which is formed from any other suitable material having EMI/RFI shielding properties. For instance, copper, aluminum, and tin are suitable alternative materials.

In another embodiment, there is provided a method of upgrading the performance of an electronic device 10 comprising: (a) providing the electronic device 10 having a plurality of electrical components 12; (b) identifying, out of the plurality of electrical components 12, at least one sensitive electrical component 22 that either transmits or receives electromagnetic interference during operation of the electronic device 10; (c) providing at least one ferrite plate 14, each ferrite plate 14 having a bottom side 16 and an adhesive 18 disposed on the bottom side 16; and (d) adhering a respective one of the ferrite plates 14 atop each sensitive electrical component 22, thereby shielding each sensitive electrical component 22 from either transmitting or receiving electromagnetic interference.

According to this embodiment, there is provided the additional step of identifying sensitive electrical components 22 out of the electrical components 12 found in the electronic device 10. In this regard, a “sensitive” electrical component 22 is defined as any electrical component 12 which either produces EMI or RFI, or otherwise has its performance disturbed or degraded by EMI/RFI that it receives. Thus, the most sensitive components are identified and shielded. This identification step can include identifying all of the sensitive electrical components 22, or identifying only one or more of the sensitive electrical components 22. Factors that determine whether a particular component is sensitive can include: the type of electrical component 12, the distance of the electrical component 12 from a known EMI/RFI source, the strength of the EMI/RFI surrounding the electrical component 12, and so forth.

In yet another embodiment, there is provided a method of shielding a wire 24 from electromagnetic interference comprising: (a) providing an electronic device 10 including a wire 24 which transmits electrical current during use of the electronic device 10; (b) providing a flexible elongated tape 26 having electromagnetic-shielding properties, the tape 26 having an adhesive 28 disposed on a bottom side 30 of the tape 26; and (c) wrapping the tape 26 around the wire 24 to cover a continuous length of the wire 24 with the tape 26, thereby shielding the wire 24 from electromagnetic interference. Preferably, the tape 26 is wrapped around the wire 24 helically.

According to this embodiment, the wire 24 can comprise a power cord or any other type of electrical conduit. The tape 26 has EMI/RFI shielding properties and comprises a metalized backing 32, which can include materials such as aluminum, silver, copper, nickel, or the like. Likewise, the tape 26 includes the adhesive 28 on the bottom side 30 for wrapping the tape 26 around the wire 24. The adhesive 28 is preferably a pressure-sensitive adhesive having a protectable liner (not shown) which is easily peeled or released. The pressure-sensitive adhesive 28 can be any suitable type, such as an acrylic.

It is understood that any other suitable alternatives to carrying out the present invention can be employed. For instance, the ferrite shield can be replaced by ferrite halves, ferrite cylinders, ferrite beads, ferrite SMD chips, ferrite clamps, ferrite clips, or ferrite dust, and can be used on any consumer or professional audio or video or computerized electronic item, including AC or DC power cords positioned either inside or outside of the item, including audio or video interconnects.

In addition to upgrading the performance of the electronic device 10 by shielding the electrical components 12 from EMI/RFI, it is also believed that the ferrite plates 14 lower the operating temperature and extend the overall lifespan of the device. This is accomplished first by reducing “out-of-intended bandwidth” energies from entering the electrical component 12 from the airwaves. This reduces the workload within the electrical component 12 by not having to reproduce, pass along, or be interfered by the “out-of-intended bandwidth” frequencies, rather handling only the “intended bandwidth” frequencies of the original signal or energies.

In addition, by greatly reducing the “out-of-intended bandwidth” signals being input to the electrical component 12, this reduces the load on the associated power supply storage capacitors, thus freeing up more power storage and reducing ripple currents which measurably improves performance of the electronic device 10 through maintaining signal fidelity and reducing distortions.

In turn, this also dramatically reduces thermal heat expenditure. The ferrite plate 14 itself acts as a heatsink to the electrical component 12, thereby providing a second method of reducing internal electrical component 12 temperature and extending the lifespan.

As is apparent from the preceding, the present invention provides a method for upgrading the performance of an electronic device by shielding electrical components in the electronic device from electromagnetic interference.

What is claimed is:

1. A method of upgrading the performance of an electronic device comprising:
(a) providing the electronic device having at least one electrical component;
(b) providing a ferrite plate having a bottom side and an adhesive disposed on the bottom side; and
(c) adhering the ferrite plate atop one of the provided electrical components using the adhesive on the bottom side of the ferrite plate.

2. The method of claim 1 wherein the electronic device is selected from the group consisting of: preamplifiers, power amplifiers, DVD players, DVD recorders, cd/sacd players, CD recorders, Blu-Ray Disc® players, Blu-Ray Disc® recorders, laserdisc players, VCR players/recorders, satellite receivers, satellite transmitters, cable TV receivers, cable TV transmitters, cellular telephones, cellular telephone receivers, cellular telephone transmitters, plasma monitors, LED monitors, LCD monitors, laser monitors, vacuum-tube monitors, televisions, video projectors, powerline conditioners, powerline protectors, battery backups, computers, computing tablets, personal digital assistants, handheld video game consoles, video game consoles, handheld audio devices, active loudspeakers, surround-sound processors, video switchers, video routers, video amplifiers, cameras, HDMI® routers, HDMI® switchers, camcorders, microphone preamplifiers, phono preamplifiers, mixers, mastering equipment, music servers, music storage devices, movie storage devices, routers, home automation devices, stereo receivers, surround sound A/V receivers, digital-to-analog converters, analog-to-digital converters, transports, buffers, equalizers, post-processing devices, enhancers, scalers, and imaging devices.

3. The method of claim 2 wherein the ferrite plate has a length and a width that are substantially the same as that of the electrical component upon which the ferrite plate is adhered.

4. The method of claim 1 wherein the electrical component is selected from the group consisting of: voltage regulators, diodes, rectifiers, digital chips, computer chips, memory chips, op-amps, transistors, resistors, VLSI chips, LSI chips, audio chips, video chips, circuit board traces, opto-couplers, relay housings, plugs, relays, flat-ribbon connectors, circuit board connectors, fuses, and flat-ribbon conductors.

5. The method of claim 1 wherein the ferrite plate has a length and a width that are substantially the same as that of the electrical component upon which the ferrite plate is adhered.

6. The method of claim 1 wherein the adhesive is a pressure-sensitive adhesive.

7. The method of claim 1 wherein each ferrite plate is about 0.5 mm to about 5.0 mm thick.

8. The method of claim 1 wherein the ferrite plate includes at least one of the materials selected from the group consisting of: manganese, zinc, cobalt, and nickel.

9. The method of claim 1 wherein the adhesive is a pressure-sensitive adhesive.

10. A method of upgrading the performance of an electronic device comprising:
(a) providing the electronic device having a plurality of electrical components;
(b) identifying, out of the plurality of electrical components, at least one sensitive electrical component that either transmits or receives electromagnetic interference during operation of the electronic device;
(c) providing at least one ferrite plate, each ferrite plate having a bottom side and an adhesive disposed on the bottom side; and
(d) adhering a respective one of the ferrite plates atop each sensitive electrical component, thereby shielding each sensitive electrical component from either transmitting or receiving electromagnetic interference.

11. The method of claim 10 wherein the electronic device is selected from the group consisting of: preamplifiers, power amplifiers, DVD players, DVD recorders, cd/sacd players, CD recorders, Blu-Ray Disc® players, Blu-Ray Disc® recorders, laserdisc players, VCR players/recorders, satellite receivers, satellite transmitters, cable TV receivers, cable TV transmitters, cellular telephones, cellular telephone receivers, cellular telephone transmitters, plasma monitors, LED monitors, LCD monitors, laser monitors, vacuum-tube monitors, televisions, video projectors, powerline conditioners, powerline protectors, battery backups, computers, computing tablets, personal digital assistants, handheld video game consoles, video game consoles, handheld audio devices, active loudspeakers, surround-sound processors, video switchers, video routers, video amplifiers, cameras, HDMI® routers, HDMI® switchers, camcorders, microphone preamplifiers, phono preamplifiers, mixers, mastering equipment, music servers, music storage devices, movie storage devices, routers, home automation devices, stereo receivers, surround sound A/V receivers, digital-to-analog converters, analog-to-digital converters, transports, buffers, equalizers, post-processing devices, enhancers, scalers, and imaging devices.

12. The method of claim 11 wherein the ferrite plate has a length and a width that are substantially the same as that of the electrical component upon which the ferrite plate is adhered.

13. The method of claim 10 wherein the electrical component is selected from the group consisting of: voltage regulators, diodes, rectifiers, digital chips, computer chips, memory chips, op-amps, transistors, resistors, VLSI chips, LSI chips, audio chips, video chips, circuit board traces, opto-couplers, relay housings, plugs, relays, flat-ribbon connectors, circuit board connectors, fuses, and flat-ribbon conductors.

14. The method of claim 10 wherein the ferrite plate has a length and a width that are substantially the same as that of the electrical component upon which the ferrite plate is adhered.

15. The method of claim 10 wherein each ferrite plate is about 0.5 mm to about 5.0 mm thick.

16. The method of claim 10 wherein the ferrite plate includes at least one of the materials selected from the group consisting of: manganese, zinc, cobalt, and nickel.

17. The method of claim 10 wherein the adhesive is a pressure-sensitive adhesive.

18. A method of shielding a wire from electromagnetic interference comprising:
(a) providing an electronic device including a wire which transmits electrical current during use of the electronic device;
(b) providing a flexible elongated tape having electromagnetic-shielding properties, the tape having an adhesive disposed on a bottom side of the tape; and
(c) wrapping the tape around the wire to cover a continuous length of the wire with the tape, thereby shielding the wire from electromagnetic interference.

19. The method of claim 18 wherein the electronic device is selected from the group consisting of: preamplifiers, power amplifiers, DVD players, DVD recorders, cd/sacd players, CD recorders, Blu-Ray Disc® players, Blu-Ray Disc® recorders, laserdisc players, VCR players/recorders, satellite receivers, satellite transmitters, cable TV receivers, cable TV transmitters, cellular telephones, cellular telephone receivers, cellular telephone transmitters, plasma monitors, LED monitors, LCD monitors, laser monitors, vacuum-tube monitors, televisions, video projectors, powerline conditioners, powerline protectors, battery backups, computers, computing tablets, personal digital assistants, handheld video game consoles, video game consoles, handheld audio devices, active loudspeakers, surround-sound processors, video switchers, video routers, video amplifiers, cameras, HDMI® routers, HDMI® switchers, camcorders, microphone preamplifiers, phono preamplifiers, mixers, mastering equipment, music servers, music storage devices, movie storage devices, routers, home automation devices, stereo receivers, surround sound A/V receivers, digital-to-analog converters, analog-to-digital converters, transports, buffers, equalizers, post-processing devices, enhancers, scalers, and imaging devices.

20. The method of claim 18 wherein the adhesive is a pressure-sensitive adhesive.
